(19) United States
(12) Patent Application Publication
(10) Pub. No.: US 2007/0116802 A1
(43) Pub. Date: May 24, 2007

(54) High quality caloric composition

(76) Inventor: Carl Germano, New City, NY (US)

Correspondence Address: SCHWEITZER CORNMAN GROSS & BONDELL LLP, 292 MADISON AVENUE - 19th FLOOR, NEW YORK, NY, 10017, US

(21) Appl. No.: 11/286,230

(22) Filed: Nov. 23, 2005

(51) Int. Cl. A23L 1/30

(52) U.S. Cl. 426/72

(57) ABSTRACT

A high quality nutritional composition for patients undergoing chemotherapy or radiation therapy or suffering chronic medical conditions comprises in combination: (A) Macronutrients comprising: (1) fat (2) protein (3) high quality carbohydrate and (B) micronutrients comprising (1) essential vitamins and minerals (2) Omega 3 DHA (docosahexaenoic acid) and (3) FOS (fructooligosaccharides).

### BACKGROUND OF THE INVENTION

Nutrition can be affected by symptoms experienced due to cancer and cancer treatments, as well as psychological involvement such as depression or anxiety.

For cancer patients, nutrition during chemotherapy is important. The main goal before, during and after treatment, is to maintain adequate calories for weight maintenance and adequate protein to optimize the immune system, strength, and tolerance to treatments. While striving for adequate calories and protein during chemotherapy, one should include a well-balanced diet to minimize nutritional deficiencies. While chemotherapy and radiation can kill cancer cells, these therapies are also general toxins against body cells. A well-nourished cancer patient can protect healthy cells against the toxic effects of chemo and radiation, thus making the cancer cells more vulnerable to the medicine. Proper nutrition can make chemo and radiation more of a selective toxin against the cancer and less damaging to the patient.

Thus selecting what to eat and what not to eat are especially critical for cancer patients. Oncologists and nutritionists target to maintain or improve the patient's nutritional status while undergoing chemotherapy. During this treatment patients feel sick, lose weight and even become malnourished, so high calories and high proteins are desired to maintain the nutritional status of the patient. However, high calories and high proteins do not mean low quality calories derived from corn oil and corn syrup. Many people still do not know that consuming refined carbohydrates is counterproductive to preventing or treating cancer. They continue to drink soft drinks containing high-fructose corn syrup and they continue to drink nutritional supplements loaded with sugars and corn syrup, oblivious to the idea that they are actually giving themselves poor quality and unhealthy calories.

Cancer nutrition comes down to dietary choice. In addition, with treatment comes a host of issues that affect the way one eats. For the vast majority of oncology patients who are unable to eat well, nutritional formulas become an integral part of their treatment and care. Similar to the dietary recommendations, a nutritional formula should not be loaded with corn oil, corn syrup and sucrose and needs to be based on good quality calories.

The present invention (nutritional formula) provides high quality calories (macronutrients), essential vitamins/minerals (micronutrients) and specialty nutrients important for the health and well being of the patient during treatment. This invention is particularly designed for those oncology patients undergoing active treatment and medical care, as well as radiation therapy.

It is necessary to utilize food sources capable of providing dense calories “as opposed to “empty calories” typically found in corn oil and corn syrups commonly found in many food compositions.

The present composition provides high quality calories in a composition free of corn oil and corn oil syrups and which serves to: (1) increase energy, (2) maintain lean muscle mass, (3) provide high quality calories and (4) improve general quality of life.

### BRIEF DESCRIPTION OF THE INVENTION

The present nutritional composition or formulation satisfies these objectives, and comprises in combination, the following:

A. Macronutrients Comprising
(1) Fat—MCT (medium chain triglycerides), DHA (docosahexaenoic acid), sunflower oil;
(2) Protein—90% derived from whey protein isolate and whey protein concentrate, and 10% of total protein from soy protein isolate as opposed to high casein products on the market; and
(3) High quality carbohydrates—maltodextrin, oat fiber. natural juice crystals, barley flower, and brown rice powder; as opposed to high fructose corn syrup-based products on the market.

B. Micronutrients/Specialty Ingredients Comprising:
(1) 24 essential vitamins and minerals;
(2) Omega 3 DHA (docosahexaenoic acid) from DHA concentrate, important for brain and heart health;
(3) FOS (fructooligosaccharides) important for GI health;
(4) HiORAC (fruit and vegetable extract blend which provide 1,200 ORAC units per serving); and
(5) Oat fiber (important for intestinal and heart health).

### DETAILED DESCRIPTION OF THE INVENTION

The present composition has a variety of features and benefits that compare favorably with other brands in the nutritional field, as illustrated in the following Table A:

It provides calorically dense high protein whole foods based on nutritional formula designed for those undergoing active treatment, such as chemotherapy or radiation.

TABLE A

| | Present | | | |
|---|---|---|---|---|
| | Nutritional | Ensure | Boost | Comments |
| Features | Composition | Supplement | Supplement | Present Composition |
| Carbohydrates | Oat fiber, brown | corn syrup | corn syrup | Present composition |
| | rice flour, barley | sucrose | sucrose | contains high quality |
| | flour, FOS, cane | | | carbohydrates compared |
| | juice, maltodextrin | | | to corn syrup and sucrose, |
| | | | | which have been linked to |
| | | | | cancer, diabetes |
| | | | | and a variety of other |
| | | | | health hazards. |
| Proteins | whey protein | primarily | milk protein | High biological value, |
| | concentrate | casein | | quality proteins to maintain |
| | (90%), soy protein | | | muscle mass as opposed |
| | isolate (10%) | | | to lower biological casein |
| Fat | Omega 3 DHA | primarily | primarily | Healthy fat sources when |
| | MCT, sunflower oil | corn oil | corn oil | compared to corn oil which |
| | | | | has been linked to |
| | | | | Inflammation and |
| | | | | carcinogenesis |
| Special | Hi ORAC fruit and | none | none | Healthy source of fruits/ |
| Ingredients | Vegetable Blends, | | | vegetable extracts and |
| | OMA, FOS, oat | | | powders, healthy fibers |
| | fiber, MCT's | | | and essential fats. |

Vitamins A, C, D, E, B6, and B12, thiamin, riboflavin, niacin, folate, biotin, panothenic acid, iron, iodine, zinc, selenium, copper and chromium, along with calcium, magnesium, potassium, sodium and choline, as discussed below, are identified collectively as the “essential vitamins and minerals”.

The following table B describes key features and benefits of the present composition in detail. Key ingredients are: Omega 3 DHA, MCT, FOS and fruit/vegetable extract and powder blends.

TABLE B

| Features of Present Nutritional | |
|---|---|
| Composition | Benefits |
| Carbohydrates - | Healthy carbohydrates contribute to |
| oat fiber, barley | maintain or improve the nutritional |
| flour, brown rice | status during cancer treatment to |
| flour, cane juice, | improve the nutritional status of |
| fructoligosaccahrides (FOS) | the patient and maintain a healthy |
| | immune system |
| Proteins - whey concentrate | Good quality proteins to maintain |
| (90%) and soy protein | the lean muscle mass and improve the |
| isolate (10%) | nutritional status of the patient |
| | during cancer treatment and maintain |
| | a healthy immune system |
| Fats - Omega 3 DHA | Good fats which are proven to be |
| (docosahexaenoic acid | protective and helps to improve the |
| from fish oil), medium chain | nutritional status of the patient |
| triglycerides, sunflower oil | during cancer treatment and maintain |
| | a healthy immune system |
| FOS | GI health |
| Availability - in powdered | Easy to carry and store |
| Packets | |
| Mixing - add to cold water, | Variety of options mixes easily, |
| juice or milk | smooth texture, tastes great. |
| Other Specialty Ingredients - | Composition |
| Hi ORAC fruit blends, | Fruit Blend: melon extract, wild |
| Hi ORAC vegetable blend | bluberry extract, grape and grape |
| | seed extract, raspberry and |
| | raspberry seed extract, cranberry |
| | powder, prune powder, tart cherry |
| | powder, wild bilberry extract, |
| | strawberry powder. |
| | Vegetable Blend: broccoli powder, |
| | broccoli extract, tomato powder, |
| | carrot powder, spinach powder, kale |
| | powder, brussel sprout powder, |
| | onion extract. |

The present formulation is typically to be provided pre-packaged, such as in a 15 packet package, with one packet having approximately 80-95 grams of the formulation. Flavorings may be added to improve palatability. Typical desirable flavors may include vanilla (“Vanilla Twist”), chocolate (“Chocolate Fudge”), and fruit (“Fruit Smoothie”). A packet is added to 6-8 oz glass of cold water, stirred well and consumed immediately. As a nutritional supplement 1-4 servings or packets may be administered daily, or as directed by a health practitioner. For maximum absorption/utilization the product is to be taken away from meals and other medications.

A large percentage of the components are common to all flavors, as is illustrated in Table C. Typical flavors, such as Fruit Smoothee, Chocolate Fudge, and Vanilla Twist formulations may, for example, have varying amounts of calcium (180-190 mg-19%), magnesium (9-25 mg, 2-6%), potassium (135-290 mg, 4-8%) and sodium (90-165 mg, 4-7%).

TABLE C
Formulation Supplement Facts
Supplement Facts
Serving Size: 1 packet (83-90 g)

| | Amount Per | | % Daily |
|---|---|---|---|
| | Serving | | Value |
| Calories | 350 | | |
| Calories From Fat | 72 | | |
| Total Fat | 8 | g | 12%* |
| Saturated Fat | 6 | g | 25%* |
| Cholesterol | 30-35 | mg | 11% |
| Total Carbohydrate | 55 | g | 18% |
| Dietary Fiber | 3 | g | 12%* |
| Sugars | 6 | g | † |
| Protein | 15 | g | 30% |
| Vitamin A (as retinyl palmitate) | 1250 | IU | 25% |
| Vitamin C (as ascorbic acid) | 15 | mg | 25% |
| Vitamin D (as oholecalciferol) | 100 | IU | 25% |
| Vitamin E (as d-alpha-tocopheryl acetate) | 7.5 | IU | 25% |
| Thiamin (as thiamin HCl) | 0.375 | mg | 25% |
| Riboflavin | 0.425 | mg | 25% |
| Niacin (as niacinamide) | 5 | mg | 25% |
| Vitamin B6 (as pyridoxine HCl) | 0.5 | mg | 25% |
| Folate (as folic acid) | 100 | mcg | 25% |
| Vitamin B12 (as cyanocobalamin) | 1.5 | mcg | 25% |
| Biotin | 75 | mcg | 25% |
| Pantothenic acid | 2.5 | mg | 25% |
| Calcium (as dicalcium phosphate and | 180-190 | mg | 19% |
| from whey protein) | | | |
| Iron (as ferrous fumerate) | 2.25 | mg | 13% |
| Iodine (as potassium iodide) | 37.5 | mcg | 25% |
| Magnesium (as whey protein) | 9.25 | mg | 6% |
| Zinc (as zinc amino acid cholate) | 3.76 | mg | 25% |
| Selenium (as selenium amino acid cholate) | 17.5 | mcg | 25% |
| Copper (as copper amino acid cholate) | 0.25 | mg | 13% |
| Chromium (as chromium anicotinate | 30 | mcg | 25% |
| glycinate) | | | |
| Sodium | 90-165 | mg | 7% |
| Potassium (as soy and whey protein) | 130-290 | mg | 8% |
| Proprietary Fruit and Vegetable | 300 | mg | † |
| Extract/Powder Blend: | | | |
| Fruit Blend (150 mg): wild blueberry | | | |
| extract, grape and grape seed extract, | | | |
| raspberry and raspberry seed extract, | | | |
| cranberry powder, prune powder, tart | | | |
| cherry powder, wild bilberry extract, | | | |
| strawberry powder | | | |
| Vegetable Blend (150 mg): broccoli | | | |
| extract, tomato powder, spinach powder, | | | |
| carrot powder, kale powder, brussel | | | |
| sprout powder, onion extract. | | | |
| Omega 3 DHA (docosahexaenoic acid from | 100 | mg | † |
| fish oil) | | | |
| Choline (from choline bitartare | 138 | mg | † |
| FOS (fructooligosaccharides from chicory | 1000 | mg | † |
| root) | | | |
| MCT (medium chain triglycerides) | 5 | g | † |

*Percent Daily Values are based on a 2,000 calorie diet
† Daily value not established

The following describes the key components of the present composition and their importance.

Fruit and Vegetable Extracts

The traditional western diet is based on animal foods, such as meat and dairy products, and does not contain a lot of plant foods including fruits, vegetables, and whole grains, and has been linked to many diseases, such as cardiovascular disease, cancer, stroke, diabetes, etc. Based on analysis from research institutes such as the National Cancer Institute and American Institute for Cancer Research, individuals are urged to eat a varied, well-balanced diet, rich in dark, leafy greens (5-9 servings of fruits and vegetables) because of theft abundant phytonutrient content. The issue is that the majority of individuals neither have the time nor the ability to eat this quantity. Hence, our reliance on vegetable and fruit powders those are capable of delivering the health promoting effects in a convenient, easy-to-consume beverage form.

At the cornerstone of all nutritious diets are dark leafy greens, vegetables and fruits, such as:

Kale, carrots and spinach, which contain an ample supply of vitamins A and C, calcium and carotenoids such as lutein.

Broccoli, which contains folate, vitamins A, C and K, potassium, phosphorus, calcium, lutein, beta-carotene and is specifically rich in glucosinolates and isothiacyanates that activate detoxification enzymes and boost antioxidant and cellular protection.

Tomatoes, which contain folate, vitamins A and C, potassium, phosphorus, magnesium, zeaxanthin, lutein and lycopene, a powerful antioxidant that provides support for cardiovascular and prostate health.

Blueberry, bilberry, elderberry, prune, cherry, raspberry, cranberry and strawberry which contain important polyphenols that provide potent antioxidant protection and have a high ORAC profile. A measure of the antioxidant capacity of fruits and vegetables is called oxygen radical absorptive capacity (ORAC). The ORAC test measures the ability of a substance to disarm oxygen free radicals. According to a study at a leading university, the antioxidant capacity of a single serving of mixed fruits and vegetables can range from 600 to 1,200 ORAC units. The present composition supplies at least 1,200 ORAC units per serving.

DHA

DHA (docosahexaenoic acid) is a member of the omega-3 group of fatty acids found in fish and happens to be one of the most abundant fatty acids in the human brain. In the fetus and young infants, DHA is essential for proper growth and development of the brain, nervous system, and the retina of the eye. Because DHA is present in breast milk and not in cow's milk, many physicians recommend breast-feeding or the use of infant formula that contains DHA. There is a thinking that DHA is primarily involved in the growth and development of the brain and nervous system, as well as the retina. However, these functions may make it useful for the treatment and support of a number of health conditions.

DHA has the potential to improve a number of serious health problems that afflict Americans. American diets are typically deficient in fish that are rich in omega-3 fatty acids, so we don't consume very much of these health-promoting compounds. In fact, Americans ingest only about 0.1-0.2 gram of omega-3 fatty acids daily, on average. This is significantly less than the recommended amount, which can be obtained by eating two to three servings of coldwater fish per week.

For most people, however, that is an unreliable and expensive way to get their omega-3 fatty acids. Supplementation is much more reliable and convenient for those who seek DHA as a means to improve their cognitive function, heart health, mood, reduce inflammation and more.

A number of clinical and research studies suggest that fats containing omega-3 fatty acids, in particular DHA, are vital for cognitive function, especially as we get older and our faculties tend to decline. Beyond cognition (the ability to perceive and interpret information correctly), DHA is essential for many other important brain functions. It has a significant impact on behavior and learning and is critical for proper neural development in infants and children. The research on omega-3 fatty acids, and DHA in particular, is impressive. In addition to improving brain and heart function, there is evidence that DHA can reduce the symptoms of inflammatory conditions and is useful in cancer therapy. It is speculated that DHA may be able to moderate the production of inflammation-producing compounds and thus decrease the incidence of inflammation that leads to these debilitating diseases.

FOS

Fructooligosaccharides (FOS) refer to a class of non-digestible carbohydrates or sugars that occur naturally in a wide variety of foods throughout the plant kingdom. Since they are non-digestible, they pass through the human digestive virtually unchanged. When the fructooligosaccharides reach the colon, they are used by the good or beneficial bacteria found there (known as bifidobacteria or bifidus) for growth and multiplication. A healthy population of these beneficial bacteria in the digestive tract enhances the digestion and absorption of nutrients, detoxification and elimination processes, and helps boost the immune system. Since fructooligosaccharides are non-digestible, they provide almost no calories and are thus used as substitute sweeteners as well. It is becoming increasingly recognized that probiotic products containing beneficial bacteria such as lactobacillus and bifidobacteria organisms can be useful in the prevention and treatment of diarrhea caused by taking certain medications. Many of these commercial products also contain fructooligosaccharides, which enhance the benefits of the beneficial bacteria. Fructooligosaccharides can also help maintain a healthy balance of the “good” bacteria with the “had” bacteria in the digestive tract. When the “bad” bacteria dominate, a condition known as “dysbiosis” can occur. Dysbiosis can then lead to other problems throughout the body. Fructooligosaccharides may also be of benefit in helping to relieve constipation and other gastrointestinal disorders, including problems related to irritable bowel syndrome, inflammatory bowel disease, and lactose intolerance.

Whey Protein

Whey, a protein derived from milk, has been recognized as a functional food with a number of health benefits. The biological components of whey, including lactoferrin, beta lactoglobulin, alpha-lactalbumin, glycomacropeptide and immunoglobulins, demonstrate a range of interesting immune enhancing properties. In addition, whey has the ability to act as an antioxidant, antihypertensive, antiviral and antibacterial agent. The primary mechanism by which whey is thought to exert its effects is by conversion of the amino acid cysteine to glutathione—a powerful intracellular antioxidant that works with SOD for total cellular defense.

The most commonly used criterion to measure quality of a protein is Biological Value (BV). Proteins with the highest BV are the most potent lean tissue sparing and growth promoting proteins. Whey protein concentrate has long been a favorite of athletes because it is the best protein for tissue repair and muscle building. It is naturally rich in branched chain amino acids (BCAA)—leucine, isoleucine and valine. These branched chain amino acids must be present in the muscle cell to promote protein synthesis, help increase the bio-availability of complex carbohydrates and are absorbed by muscle cells to be used as sources of energy to make muscle work more efficiently. Whey proteins are highly recommended for athletes and athletic individuals as they help in speedy repairing of injured and torn muscles during practice and performance. Whey is also considered a complete protein, which contains all the essential and non-essential amino acids, and has the highest biological value (BV) of any available protein. Biological value refers to a protein that contains all of the essential amino acids in adequate quantities to sustain growth and development.

One skilled the art will recognize that various modifications may be made to the invention as specifically recited herein. That which is sought to be protected is set forth in the following claims.

I claim:

1. A high quality nutritional composition for patients undergoing chemotherapy or radiation therapy or suffering chronic medical conditions comprising in combination:
(A) macronutrients comprising:
(1) fat
(2) protein
(3) high quality carbohydrates and
(B) micronutrients/specialty ingredients, comprising
(1) essential vitamins and minerals
(2) Omega 3 DHA (docosahexaenoic acid)
(3) FOS (fructooligosaccharides)
(4) fruit and vegetable extracts/powders.

2. The composition of claim 1 wherein said fat is selected from the group comprising Omega 3 DHA, sunflower oil, and medium chain triglycerides (MCT).

3. The composition of claim 1 wherein said protein is selected from the group comprising whey protein concentrate and soy protein isolate.

4. The composition of claim 1 wherein said carbohydrates are selected from the group comprising oat fiber, barley flour, brown rice flour, maltodextrin and fructoligooligosaccharides (FOS).

5. The composition of claim 1 which further contains Hi ORAC fruit blends and Hi ORAC vegetable blends.

6. A high quality nutritional composition for patients undergoing therapy or suffering chronic medical conditions comprising in combination:
(A) macronutrients comprising in combination
(1) a fat component selected from the group comprising Omega 3 DHA (docosahexaenoic acid from fish oil), sunflower oil, and MCT (medium chain triglycerides)
(2) a protein component selected from the group comprising whey protein concentrate and soy protein isolate
(3) a carbohydrate component selected from the group comprising oat fiber, barley fiber, brown rice, maltodextrin and FOS (fructooligosaccharides), and
(B) micronutrients comprising in combination
(1) essential vitamins and minerals
(2) OMEGA 3 DHA (docosahexaenoic acid)
(3) Hi ORAC fruit and vegetable blends.

7. A method of providing nutrition to an individual, comprising the oral administration of a nutrient composition containing a combination of:
macronutrients comprising fat, protein and high quality carbohydrates; and
micronutrients comprising essential vitamins and minerals, omega 3 DHA, and FOS.

8. The method of claim 7, wherein said nutrient composition further contains specialty ingredients selected from the group consisting of HI ORAC fruit and vegetable blends, Omega DHA, FOS, MCTs and oat fiber.
